(19) United States
(12) Patent Application Publication
(10) Pub. No.: US 2025/0388801 A1
(43) Pub. Date: Dec. 25, 2025

(54) FURFURYL ALCOHOL MONOMER CONSOLIDATION TREATMENT

(71) Applicant: Halliburton Energy Services, Inc., Houston, TX (US)

(72) Inventors: Philip D. NGUYEN, Houston, TX (US); Michael Wayne SANDERS, Houston, TX (US); Julio Estuardo VASQUEZ ESTRADA, Houston, TX (US)

(73) Assignee: Halliburton Energy Services, Inc., Houston, TX (US)

(21) Appl. No.: 18/750,703

(22) Filed: Jun. 21, 2024

(51) Int. Cl. C09K 8/508; C09K 8/035; C09K 8/518; C09K 8/72; C09K 8/80; E21B 43/02; E21B 43/267

(52) U.S. Cl. CPC C09K 8/5086; C09K 8/035; C09K 8/518; C09K 8/725; C09K 8/80; E21B 43/025; E21B 43/267

(57) ABSTRACT

Treatment fluids and methods for performing a consolidation operation. An example treatment fluid includes an aqueous base fluid, a furfuryl alcohol monomer, a delayed-release acid activator, an oil-wetting surfactant, and a silane coupling agent. A particulate and/or a target area of a subterranean formation is contacted with the treatment fluid to consolidate the particulate and/or target area of the formation.

### TECHNICAL FIELD

The present disclosure relates generally to wellbore operations, and more particularly, to the use of a furfuryl alcohol monomer to prepare a consolidation treatment for various wellbore operations.

### BACKGROUND

Natural resources such as gas, oil, and water residing in a subterranean formation may be recovered from a wellbore. During the production phase of a wellbore, these resources may be recovered through their flow out of a permeable portion of the subterranean formation and into the wellbore. In some operations, the permeability of the subterranean formation may be increased through hydraulic fracturing. Fluid conductivity through the subterranean formation and the wellbore may be impacted by the migration of particulates within the subterranean formation and the wellbore. These particulates may block flow channels within the subterranean formation such as the pores in the rock, the interstitial spaces between proppant particulates in a proppant pack, the interstitial spaces between gravel in a gravel pack, etc. The prevention of particulate migration may maintain stable and productive flow channels for production operations.

Some formations may not possess sufficient stability for production and may collapse or produce particulates which may migrate and impede flow channels. Other formations may be weakened by drilling operations and may become unstable potentially leading to collapse or the production of particulates which may impede downstream flow channels. Stabilizing these formations may improve production and reduce the migration of particulates.

Consolidation of particulates and formations is an important part of some wellbore operations. The present disclosure provides improved consolidation treatments for various wellbore operations.

### BRIEF DESCRIPTION OF THE DRAWINGS

Illustrative examples of the present disclosure are described in detail below with reference to the attached drawing figures, which are incorporated by reference herein, and wherein:

FIG. 1 is an illustrative schematic of a system that can deliver examples of the treatment fluids to a downhole location in accordance with one or more examples described herein;

FIG. 2 is an illustrative schematic of a drilling assembly in which a drilling fluid containing the treatment fluid as a component part is used in accordance with one or more examples described herein;

FIG. 3 is a cross-section illustrating the use of the treatment fluids described herein to consolidate proppant within a fracture of a subterranean formation in accordance with one or more examples described herein; and

FIG. 4 is a cross-section illustrating a formation or sand consolidation operation using the treatment fluids described herein in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to wellbore operations, and more particularly, to the use of a furfuryl alcohol monomer to prepare a consolidation treatment for various wellbore operations.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized, and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present disclosure. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

The terms “uphole” and “downhole” may be used to refer to the location of various components relative to the bottom or end of a well. For example, a first component described as uphole from a second component may be further away from the end of the well than the second component. Similarly, a first component described as being downhole from a second component may be located closer to the end of the well than the second component.

The terms “upstream” and “downstream” may be used to refer to the location of various components relative to one another in regards to the flow of a sample through said components. For example, a first component described as upstream from a second component will encounter a sample before the downstream second component encounters the sample. Similarly, a first component described as being downstream from a second component will encounter the sample after the upstream second component encounters the sample.

As used herein the weight/volume percentage (“w/v”) is to be understood to mean the grams/100 milliliters.

The present disclosure relates generally to wellbore operations, and more particularly, to the use of a furfuryl alcohol monomer to prepare a consolidation treatment for various wellbore operations. Advantageously, the treatment fluid comprises a furfuryl alcohol monomer instead of relatively more expensive epoxy-based or furan-based resins. As a further advantage, the treatment fluid provides consolidation in a single-stage process and does not require a separate or distinct activator or catalyst fluid to be introduced after the treatment fluid to initiate the polymerization and/or curing. One additional advantage is that the furfuryl alcohol monomer is readily dispersed in aqueous base fluids such as brines. Moreover, the furfuryl alcohol monomer has a high flashpoint similar to water and may be safer to use than some resin systems with lower flashpoints. Yet another advantage is that the treatment fluid may be stably foamed allowing for the treatment of long intervals, including those with high contrast permeabilities, such as fractures, propped fractures, perforated case holes, and open hole wellbores. Additionally, the treatment fluid is a relatively low viscosity fluid and maintains a low viscosity through the treatment and placement process. The treatment fluid comprises a delayed-release acid activator that allows for the furfuryl alcohol monomer to begin polymerization at a target temperature and time within the wellbore. Another advantage is that the treatment fluid may optionally comprise a metal salt catalyst that improves the functionality of the treatment fluid at low temperatures, such as wellbore/formation temperatures below 150° F. For higher temperature operations, the delayed-release acid activator may not be included and consolidation may be activated from temperature alone.

The treatment fluids comprise a furfuryl alcohol monomer. The furfuryl alcohol monomer may be used in the treatment fluid to consolidate particulates and/or to stabilize formations reducing their chance of collapse or sloughing of particulates from the formation. The furfuryl alcohol monomer polymerizes downhole at a desired time and location due to the delayed release of an acid from the delayed-release acid activator present in the treatment fluid. Wellbore and/or formation temperature also influences the polymerization of the furfuryl alcohol monomer and in some high temperature examples, temperature alone may be sufficient to induce polymerization. As the furfuryl alcohol monomer polymerizes, it forms crosslinks which result in the consolidation of the target particulates and/or formation.

The furfuryl alcohol monomer is a monomer of (Furan-2-yl)methanol which may polymerize to form a furan resin. The concentration of the furfuryl alcohol monomer in a treatment fluid may range from about 0.1% w/v to about 80% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the furfuryl alcohol monomer in the treatment fluid may range from about 0.1% (w/v) to about 80% (w/v), from about 0.5% (w/v) to about 80% (w/v), from about 1% (w/v) to about 80% (w/v), from about 2% (w/v) to about 80% (w/v), from about 3% (w/v) to about 80% (w/v), from about 4% (w/v) to about 80% (w/v), from about 5% (w/v) to about 80% (w/v), from about 6% (w/v) to about 80% (w/v), from about 7% (w/v) to about 80% (w/v), from about 8% (w/v) to about 80% (w/v), from about 9% (w/v) to about 80% (w/v), from about 10% (w/v) to about 80% (w/v), from about 20% (w/v) to about 80% (w/v), from about 30% (w/v) to about 80% (w/v), from about 40% (w/v) to about 80% (w/v), from about 50% (w/v) to about 80% (w/v), from about 60% (w/v) to about 80% (w/v), or from about 70% (w/v) to about 80% (w/v). As another example, the concentration of the furfuryl alcohol monomer in the treatment fluid may range from about 0.1% (w/v) to about 80% (w/v), from about 0.1% (w/v) to about 70% (w/v), from about 0.1% (w/v) to about 60% (w/v), from about 0.1% (w/v) to about 50% (w/v), from about 0.1% (w/v) to about 40% (w/v), from about 0.1% (w/v) to about 30% (w/v), from about 0.1% (w/v) to about 20% (w/v), from about 0.1% (w/v) to about 10% (w/v), from about 0.1% (w/v) to about 9% (w/v), from about 0.1% (w/v) to about 8% (w/v), from about 0.1% (w/v) to about 7% (w/v), from about 0.1% (w/v) to about 6% (w/v), from about 0.1% (w/v) to about 5% (w/v), from about 0.1% (w/v) to about 4% (w/v), from about 0.1% (w/v) to about 3% (w/v), from about 0.1% (w/v) to about 2% (w/v), from about 0.1% (w/v) to about 1% (w/v), or from about 0.1% (w/v) to about 0.5% (w/v). With the benefit of this disclosure, one of ordinary skill in the art will be readily able to prepare and select a furfuryl alcohol monomer having a desirable concentration for use in a given treatment fluid.

The treatment fluids described herein comprise a delayed-release acid activator. The delayed-release acid activator may be used to initiate polymerization of the furfuryl alcohol monomer. Examples of the delayed-release acid activator include, but are not limited to, esters, acid chlorides, orthoesters, formates, lactides, lactic acid derivatives, carbonates, amino acids, glycolides, ε-caprolactones, hydroxy ester ethers, hydroxybutyrates, anhydrides, phosphazenes, methyl lactate, ethyl lactate, propyl lactate, butyl lactate, formate esters (e.g., ethylene glycol monoformate, ethylene glycol diformate, diethylene glycol diformate, glyceryl monoformate, glyceryl diformate, glyceryl triformate, triethylene glycol diformate and formate esters of pentaerythritol), esters or polyesters of glycerol (e.g., tripropionin (a triester of propionic acid and glycerol), trilactin, etc.) esters of acetic acid and glycerol (e.g., monoacetin, diacetin, and triacetin), sulfonate esters (e.g., methyl p-toluenesulfonate, ethyl p-toluenesulfonate, methyl methanesulfonate, ethyl methanesulfonate, methyl benzenesulfonate, ethyl benzenesulfonate, methyl 2,4,6-trimethylbenzenesulfonate, ethyl 2,4,6-trimethylbenzenesulfonate), aliphatic polyesters, poly(lactides), poly(glycolides), poly(ε-caprolactones), poly(hydroxy ester ethers), poly(hydroxybutyrates), poly(anhydrides), aliphatic polycarbonates, poly(orthoesters), poly(amino acids), poly(ethylene oxides), polyphosphazenes, copolymers thereof, and/or any combination thereof.

The concentration of the delayed-release acid activator in a treatment fluid may range from about 0.1% w/v to about 25% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the delayed-release acid activator in the treatment fluid may range from about 0.1% (w/v) to about 25% (w/v), from about 0.5% (w/v) to about 25% (w/v), from about 1% (w/v) to about 25% (w/v), from about 2% (w/v) to about 25% (w/v), from about 3% (w/v) to about 25% (w/v), from about 4% (w/v) to about 25% (w/v), from about 5% (w/v) to about 25% (w/v), from about 6% (w/v) to about 25% (w/v), from about 7% (w/v) to about 25% (w/v), from about 8% (w/v) to about 25% (w/v), from about 9% (w/v) to about 25% (w/v), from about 10% (w/v) to about 25% (w/v), from about 15% (w/v) to about 25% (w/v), or from about 20% (w/v) to about 25% (w/v). As another example, the concentration of the delayed-release acid activator in the treatment fluid may range from about 0.1% (w/v) to about 10% (w/v), from about 0.1% (w/v) to about 9% (w/v), from about 0.1% (w/v) to about 8% (w/v), from about 0.1% (w/v) to about 7% (w/v), from about 0.1% (w/v) to about 6% (w/v), from about 0.1% (w/v) to about 5% (w/v), from about 0.1% (w/v) to about 4% (w/v), from about 0.1% (w/v) to about 3% (w/v), from about 0.1% (w/v) to about 2% (w/v), from about 0.1% (w/v) to about 1% (w/v), or from about 0.1% (w/v) to about 0.5% (w/v). With the benefit of this disclosure, one of ordinary skill in the art will be readily able to prepare and select a delayed-release acid activator having a desirable concentration for use in a given treatment fluid.

The treatment fluids described herein comprise an aqueous base fluid, for example, freshwater, saltwater (e.g., water containing one or more salts dissolved therein), brine (e.g., saturated saltwater, including saturated saltwater produced from subterranean formations), seawater, or any combination thereof. Generally, the aqueous base fluid may be from any source provided that the aqueous base fluid does not contain an excess of compounds that may undesirably affect other components in the treatment fluid. In the case of brines, the aqueous base fluid may comprise a monovalent brine or a divalent brine. Suitable monovalent brines may include, for example, sodium chloride brines, sodium bromide brines, potassium chloride brines, potassium bromide brines, ammonium chloride brines, and the like. Suitable divalent brines can include, for example, barium chloride brines, zinc chloride brines, manganese chloride brines, manganese oxide brines, calcium bromide brines, magnesium chloride brines, calcium chloride brines, and the like.

The concentration of the aqueous base fluid in the treatment fluid may range from about 1% (w/v) to about 99% (w/v). The concentration of the aqueous base fluid in the treatment fluid may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the aqueous base fluid in the treatment fluid may range from about 1% (w/v) to about 99% (w/v), from about 5% (w/v) to about 99% (w/v), from about 10% (w/v) to about 99% (w/v), from about 15% (w/v) to about 99% (w/v), from about 20% (w/v) to about 99% (w/v), from about 25% (w/v) to about 99% (w/v), from about 30% (w/v) to about 99% (w/v), from about 35% (w/v) to about 99% (w/v), from about 40% (w/v) to about 99% (w/v), from about 45% (w/v) to about 99% (w/v), from about 55% (w/v) to about 99% (w/v), from about 60% (w/v) to about 99% (w/v), from about 65% (w/v) to about 99% (w/v), from about 70% (w/v) to about 99% (w/v), from about 75% (w/v) to about 99% (w/v), from about 80% (w/v) to about 99% (w/v), from about 85% (w/v) to about 99% (w/v), from about 90% (w/v) to about 99% (w/v), or from about 95% (w/v) to about 99% (w/v). As another example, the concentration of the aqueous base fluid in the treatment fluid may range from about 1% (w/v) to about 99% (w/v), from about 1% (w/v) to about 95% (w/v), from about 1% (w/v) to about 90% (w/v), from about 1% (w/v) to about 85% (w/v), from about 1% (w/v) to about 80% (w/v), from about 1% (w/v) to about 75% (w/v), from about 1% (w/v) to about 70% (w/v), from about 1% (w/v) to about 65% (w/v), from about 1% (w/v) to about 60% (w/v), from about 1% (w/v) to about 55% (w/v), from about 1% (w/v) to about 50% (w/v), from about 1% (w/v) to about 45% (w/v), from about 1% (w/v) to about 40% (w/v), from about 1% (w/v) to about 35% (w/v), from about 1% (w/v) to about 30% (w/v), from about 1% (w/v) to about 25% (w/v), from about 1% (w/v) to about 20% (w/v), from about 1% (w/v) to about 15% (w/v), from about 1% (w/v) to about 10% (w/v), or from about 1% (w/v) to about 5% (w/v). With the benefit of this disclosure, one of ordinary skill in the art will be able to prepare a treatment fluid having a sufficient concentration of an aqueous base fluid for a given application.

The treatment fluids described herein comprise an oil-wetting surfactant. The oil-wetting surfactant may be used to alter the wettability of any particulates and/or targeted areas of the subterranean formation thereby improving the ability of furfuryl alcohol monomer to contact and consolidate the particulates or targeted areas of the subterranean formation.

Examples of the oil-wetting surfactant include, but are not limited to, alkyl phosphonate surfactants (e.g., a C₁₂-C₂₂ alkyl phosphonate surfactant), ethoxylated nonyl phenol phosphonate esters, ethoxylated C₁₂-C₂₂ diamine, ethoxylated C₁₂-C₂₂ triamine, ethoxylated C₁₂-C₂₂ tetraamine, ethoxylated C₁₂-C₂₂ diamine methylchloride quat, ethoxylated C₁₂-C₂₂ triamine methylchloride quat, ethoxylated C₁₂-C₂₂ tetraamine methylchloride quat, ethoxylated C₁₂-C₂₂ diamine reacted with sodium chloroacetate, ethoxylated C₁₂-C₂₂ triamine reacted with sodium chloroacetate, ethoxylated C₁₂-C₂₂ tetraamine reacted with sodium chloroacetate, ethoxylated C₁₂-C₂₂ diamine acetate salt, ethoxylated C₁₂-C₂₂ diamine hydrochloric acid salt, ethoxylated C₁₂-C₂₂ diamine glycolic acid salt, ethoxylated C₁₂-C₂₂ diamine DDBSA (dodecyl benzene sulfonic acid) salt, ethoxylated C₁₂-C₂₂ triamine acetate salt, ethoxylated C₁₂-C₂₂ triamine hydrochloric acid salt, ethoxylated C₁₂-C₂₂ triamine glycolic acid salt, ethoxylated C₁₁-C₂₂ triamine DDBSA salt, ethoxylated C₂-C₂₂ tetraamine acetate salt, ethoxylated C₁₂-C₂₂ tetraamine hydrochloric acid salt, ethoxylated C₁₁-C₂₂ tetraamine glycolic acid salt, ethoxylated C₁₂-C₂₂ tetraamine DDBSA salt, pentamethylated C₁₂-C₂₂ diamine quat, heptamethylated C₁₂-C₂₂ diamine quat, nonamethylated C₁₂-C₂₂ diamine quat, and combinations thereof.

The concentration of the oil-wetting surfactant in a treatment fluid may range from about 0.1% w/v to about 10% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the oil-wetting surfactant in the treatment fluid may range from about 0.1% (w/v) to about 10% (w/v), from about 0.5% (w/v) to about 10% (w/v), from about 1% (w/v) to about 10% (w/v), from about 2% (w/v) to about 10% (w/v), from about 3% (w/v) to about 10% (w/v), from about 4% (w/v) to about 10% (w/v), from about 5% (w/v) to about 10% (w/v), from about 6% (w/v) to about 10% (w/v), from about 7% (w/v) to about 10% (w/v), from about 8% (w/v) to about 10% (w/v), or from about 9% (w/v) to about 10% (w/v). As another example, the concentration of the oil-wetting surfactant in the treatment fluid may range from about 0.1% (w/v) to about 10% (w/v), from about 0.1% (w/v) to about 9% (w/v), from about 0.1% (w/v) to about 8% (w/v), from about 0.1% (w/v) to about 7% (w/v), from about 0.1% (w/v) to about 6% (w/v), from about 0.1% (w/v) to about 5% (w/v), from about 0.1% (w/v) to about 4% (w/v), from about 0.1% (w/v) to about 3% (w/v), from about 0.1% (w/v) to about 2% (w/v), from about 0.1% (w/v) to about 1% (w/v), or from about 0.1% (w/v) to about 0.5% (w/v). With the benefit of this disclosure, one of ordinary skill in the art will be readily able to prepare and select an oil-wetting surfactant having a desirable concentration for use in a given treatment fluid.

The treatment fluids comprise a silane coupling agent to covalently bind to the surface of some materials (e.g., particulates and/or formation surfaces) and then to bind the furan-based polymer resin to another end of the silane coupling agent, thereby consolidating the bound materials. In some general examples, the silane-coupling agent is an organosilane coupling agent and more specifically, an alkylaminosilane. Specific examples of the silane coupling agent include, but are not limited to, N-2-(aminoethyl)-3-aminopropyltrimethoxysilane; 3-glycidoxypropyltrimethoxysilane; gamma-aminopropyltriethoxysilane; N-beta-(aminoethyl)-gamma-aminopropyltrimethoxysilanes; aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; gamma-glycidoxypropyltrimethoxysilanes; vinyltrichlorosilane; vinyltris (beta-methoxyethoxy) silane; vinyltriethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta-(aminoethyl)-r-aminopropyl-trimethoxysilane; N-beta-(aminoethyl)-r-aminopropylmethyldimethoxysilane; 3-aminopropyl-triethoxysilane; N-phenyl-r-aminopropyltrimethoxysilane; r-mercaptopropyltrimethoxysilane; r-chloropropyltrimethoxysilane; vinyltrichlorosilane; vinyltris (beta-methoxyethoxy) silane; vinyltrimethoxysilane; r-metacryloxypropyltrimethoxysilane; beta-(3,4 epoxycyclohexyl)-ethyltrimethoxysila; r-glycidoxypropyltrimethoxysilane; r-glycidoxypropylmethylidiethoxysilane; N-beta-(aminoethyl)-r-aminopropyltrimethoxysilane; N-beta-(aminoethyl)-r-aminopropylmethyldimethoxysilane; r-aminopropyltriethoxysilane; N-phenyl-r-aminopropyltrimethoxysilane; r-mercaptopropyltrimethoxysilane; r-chloropropyltrimethoxysilane; N[3-(trimethoxysilyl)propyl]-ethylenediamine; substituted silanes where one or more of the substitutions contains a different functional group; or combinations thereof.

The concentration of the silane-coupling agent in a treatment fluid may range from about 0.25% to about 10% wt. %. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the silane-coupling agent in the treatment fluid may range from about 0.25% to about 10% wt. %, from about 0.5% to about 10% wt. %, from about 1% to about 10% wt. %, from about 2% to about 10% wt. %, from about 3% to about 10% wt. %, from about 4% to about 10% wt. %, from about 5% to about 10% wt. %, from about 6% to about 10% wt. %, from about 7% to about 10% wt. %, from about 8% to about 10% wt. %, or from about 9% to about 10% wt. %. As another example, the concentration of the silane-coupling agent in the treatment fluid may range from about 0.25% to about 10% wt. %, from about 0.25% to about 9% wt. %, from about 0.25% to about 8% wt. %, from about 0.25% to about 7% wt. %, from about 0.25% to about 6% wt. %, from about 0.25% to about 5% wt. %, from about 0.25% to about 4% wt. %, from about 0.25% to about 3% wt. %, from about 0.25% to about 2% wt. %, from about 0.25% to about 1% wt. %, or from about 0.25% to about 0.5% wt. %. In one preferred example, the concentration of the silane-coupling agent is from about 0.25% to about 5% wt. %. In another preferred example, the concentration of the silane-coupling agent is from about 0.5% to about 4% wt. %. With the benefit of this disclosure, one of ordinary skill in the art will be readily able to prepare and select a silane-coupling agent having a desirable concentration for the treatment fluid for a given application.

In some optional examples, the treatment fluids comprise a metal salt catalyst which may be used in examples where the wellbore and/or subterranean formation temperature are relatively lower (e.g., 150° F. or less). The metal salt catalyst may allow for the furfuryl alcohol monomer to polymerize and consolidate particulates and/or targeted areas of the subterranean formation in lower temperature wellbores and/or subterranean formations. Examples of the metal salt catalyst include, but are not limited to, AlCl₃, CoCl₂, CdCl₂, FeCl₃, MgCl₂, MnCl₂, NiCl₂, SnCl₄, ZnCl₂, or any combination thereof.

The concentration of the metal salt catalyst in a treatment fluid may range from about 0.1% to about 25% wt. %. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the metal salt catalyst in the treatment fluid may range from about 0.1% to about 25% wt. %, from about 0.25% to about 25% wt. %, from about 0.5% to about 25% wt. %, from about 1% to about 25% wt. %, from about 2% to about 25% wt. %, from about 3% to about 25% wt. %, from about 4% to about 25% wt. %, from about 5% to about 25% wt. %, from about 6% to about 25% wt. %, from about 7% to about 25% wt. %, from about 8% to about 25% wt. %, from about 9% to about 25% wt. %, from about 10% to about 25% wt. %, from about 15% to about 25% wt. %, or from about 20% to about 25% wt. %. As another example, the concentration of the metal salt catalyst in the treatment fluid may range, from about 0.1% to about 25% wt. %, from about 0.1% to about 20% wt. %, from about 0.1% to about 15% wt. %, from about 0.1% to about 10% wt. %, from about 0.1% to about 9% wt. %, from about 0.1% to about 8% wt. %, from about 0.1% to about 7% wt. %, from about 0.1% to about 6% wt. %, from about 0.1% to about 5% wt. %, from about 0.1% to about 4% wt. %, from about 0.1% to about 3% wt. %, from about 0.1% to about 2% wt. %, from about 0.1% to about 1% wt. %, from about 0.1% to about 0.25% wt. %, or from about 0.1% to about 0.5% wt. %. With the benefit of this disclosure, one of ordinary skill in the art will be readily able to prepare and select a metal salt-catalyst having a desirable concentration for the treatment fluid for a given application.

In some optional examples, the treatment fluids may be foamed. Foamed treatment fluids may be used to treat longer intervals. Some of these longer intervals may be high contact permeabilities, for example, propped fractures, perforated cased hole wellbores, and/or open hole wellbores. In some examples, gases can be utilized for foaming the treatment fluids, including, but not limited to, nitrogen, carbon dioxide, air, methane, and combinations thereof. In some embodiments, the foaming gas may be present in the foamed treatment fluids in an amount in the range of about 5% to about 98% by volume of the foamed treatment fluids. In other examples, a foaming agent may be used to foam the treatment fluids. In some of these examples, the foaming agents may be used in combination with the aforementioned foaming gases discussed above. Examples of foaming agents may include the oil-wetting surfactants listed above as well as other species of foaming agents including, but not limited to, betaines, amine oxides, methyl ester sulfonates, alkylamido betaines such as cocoamidopropyl betaine, alpha-olefin sulfonate, trimethyltallowammonium chloride, C₈ to C₂₂ alkylethoxylate sulfate and trimethylcocoammonium chloride. The concentration of the foaming agent used is a function of the species of foaming agent selected and the desired quality of the resultant foam.

In some optional examples, the treatment fluids may further comprise an additional additive. The additional additive may be used to adjust a property of the treatment fluid, for example, viscosity, density, etc. Examples of the additives include, but are not limited to, silica scale control additives, corrosion inhibitors, surfactants, gel stabilizers, anti-oxidants, polymer degradation prevention additives, relative permeability modifiers, scale inhibitors, iron control agents, particulate diverters, salts, fluid loss control additives, gas, catalysts, clay control agents, dispersants, flocculants, scavengers (e.g., H₂S scavengers, CO₂ scavengers or O₂ scavengers), gelling agents, lubricants, friction reducers, bridging agents, viscosifiers, weighting agents, solubilizers, hydrate inhibitors, consolidating agents, bactericides, clay stabilizers, breakers, delayed release breakers, the like, or any combination thereof. With the benefit of this disclosure, one of ordinary skill in the art and the benefit of this disclosure will be able to formulate a treatment fluid having properties suitable for a desired application.

The treatment fluids have a density suitable for a particular application. By way of example, the treatment fluids may have a density in a range of from about 4 pounds per gallon (“lb/gal”) to about 20 lb/gal, in a range of from about 8 lb/gal to about 20 lb/gal, or in a range of from about 12 lb/gal to about 20 lb/gal. With the benefit of this disclosure, those of ordinary skill in the art will readily recognize the appropriate density of a treatment fluid for a particular application.

The treatment fluids may be used in wellbores and subterranean formations having a variety of temperatures. By way of example, the wellbores and subterranean formations may have a temperature in a range of about 65° F. to about 800° F. In a specific example, the wellbore has a temperature range of between about 65° F. to about 150° F. The treatment fluid may consolidate particulates and/or targeted areas of a subterranean formation while being exposed to temperatures in the aforementioned range.

An example use for the treatment fluid includes treating propped fractures for controlling proppant flowback during well production. In this example, a pre-flush fluid may be injected into the wellbore first. The pre-flush fluid comprises an aqueous brine and an oil-wetting surfactant for preparing the proppant placed in the fractures to be effectively coated with the subsequently introduced treatment fluid. After introduction of the pre-flush fluid, the treatment fluid is introduced to initiate consolidation of the placed proppant.

Another example use of the treatment fluid includes treating targeted areas of the subterranean formations surrounding the wellbore for controlling sand production during well production or well injection. In this example, a pre-flush fluid may be injected into the wellbore first. The pre-flush fluid comprises an aqueous brine and an oil-wetting surfactant for preparing the formations surrounding the wellbore to be effectively treated with the subsequently introduced treatment fluid. After introduction of the pre-flush fluid, the treatment fluid is introduced to initiate consolidation of the subterranean formations thereby reducing the production of sand from the subterranean formations.

In some examples, a displacement fluid comprising a water or an aqueous brine is injected to the top of the perforations of a propped fracture(s), or to top of a treated interval, following the introduction of a treatment fluid. The displacement fluid may displace the treatment fluid into the propped fractures and/or the surrounding subterranean formation.

Another example use of the treatment fluid includes treating a subterranean formation in combination with acidizing treatments. In this example, an ultra-low concentration (e.g., about 0.1% w/v to about 5% w/v) of furfuryl alcohol monomer is applied in treating an interval of a subterranean formation, before and/or after the use of acidizing treatments. The treatment fluid consolidates the fines resulting from the acid treatment thereby controlling fines migration and/or fines production during well production.

In one more example use of the treatment fluid, the treatment fluid is used to treat carbonate-laden subterranean formations, either before or after acidizing treatment of the carbonate-laden formations. The treatment fluid stabilizes the carbonate-laden subterranean formations by consolidating the formations surrounding the etched surfaces or created channels.

In another example use of the treatment fluid, the treatment fluid is used to treat unconsolidated or weakly consolidated subterranean formations surrounding a wellbore before performing one or more hydraulic treatments. The treatment fluid allows the subterranean formations to gain consolidation strength such that the downhole treating pressure may be maintained thereby allowing fractures to be generated into the treated formations and to hold the formation sand in placed. By holding the formation sand in place, the sand is prevented from invading the propped fractures and reducing the propped fracture conductivity.

Another example use of the treatment fluid combines the treatment fluid with a drill-in fluid to provide a sand control treatment while drilling a production interval in a wellbore. The treatment fluid provides consolidation strength to the formations surrounding the wellbore such that a production interval can be completed with sand-screens alone (i.e., without requiring gravel pack treatments).

A further example use of the treatment fluid is to inject the treatment fluid through sand control screens to allow the treatment fluid to penetrate the subterranean formations surrounding the wellbore. The treatment fluid may enhance the consolidation strength of the treated formations and mitigate production of formation solids during well production.

Another example use of the treatment fluid is to treat clay-laden bedding planes. The treatment fluid is injected into a wellbore to contact and treat the clay-laden bedding planes, which may be interlayered between coal cleats in coal-bed methane formations. The treatment fluid may provide consolidation strength to the clay-laden bedding planes such that they can withstand water production without transforming into loose mud and producing back during gas production.

In another example use of the treatment fluid, the treatment fluid is combined with solids, such as sand, fly ash, cement, solid carbon, etc., to form a sealant composite for use in plug-and-abandonment treatments of old and depleted wells.

A further example use of the treatment fluid uses the treatment fluid as a sealant for injection into high water producing intervals (typically with high permeabilities) to shut off the production of water from these intervals.

An additional use of the treatment fluid is to include the treatment fluid as component part of a drilling fluid for use in drilling a wellbore in geothermal operations. The treatment fluid, with its ability to handle high temperatures, acts as a sealant to seal off the borehole wall thereby preventing formation fluids from entering the wellbore, or preventing the wellbore working fluid to escape into the surrounding rock formation.

Another example use of the treatment fluid is to include the treatment fluid as a component part of a fracturing fluid for use in the hydraulic fracturing of a weakly consolidated formation. The treatment fluid is allowed to permeate the rock formation surrounding the created fracture faces, thereby transforming the treated formation into a competent, permeable rock formation to hold the formation particulates in place during well production and maintain the propped fracture conductivity.

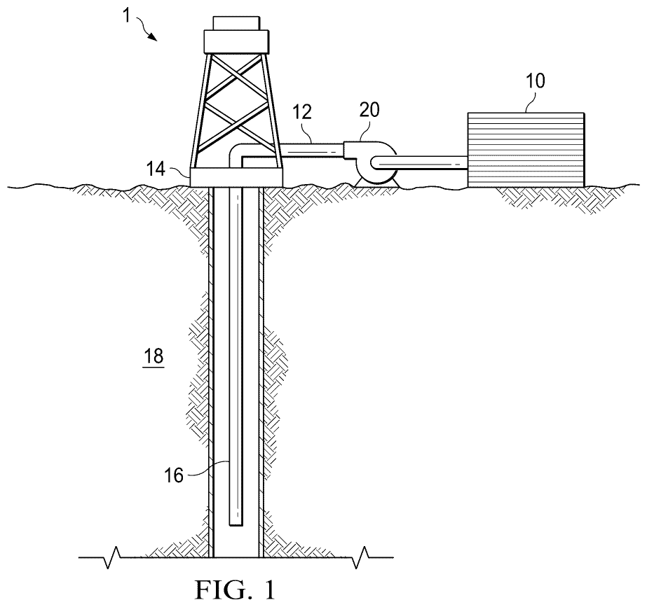

FIG. 1 shows an illustrative schematic of a system that can deliver examples of the treatment fluids to a downhole location. It should be noted that while FIG. 1 generally depicts a land-based system, it is to be recognized that like systems can be operated in subsea locations as well. As depicted in FIG. 1, a system 1 comprises a mixing tank 10, in which the treatment fluids described herein may be formulated. The components of the treatment fluid, for example, the furfuryl alcohol monomer, the aqueous base fluid, the delayed-release acid activator, the oil-wetting surfactant, and the silane coupling agent may be combined with one another in any order. Once mixed and prepared, the treatment fluids are then conveyed into the wellbore via a line 12 to the wellhead 14, where the treatment fluid enters a tubular 16, with the tubular 16 extending from the wellhead 14 into a subterranean formation 18. At a desired location, the treatment fluid is ejected from the tubular 16 to perform a wellbore operation such as consolidating proppant particulates, stabilizing targeted areas of subterranean formations, consolidating formation particulates to prevent migration, consolidating and aggregating fines thereby preventing their migration, stabilizing formation areas that have been or will be acidized, stabilizing carbonate-laden subterranean formations, stabilizing formations that are in process of being drilled, stabilizing formations that are in process of being fractured, stabilizing targeted areas of the wellbore through sand-screens but without gravel packs, stabilizing clay-laden bedding planes, and/or sealing a well so that it can be plugged and abandoned. For some of these example wellbore operations, a pre-flush fluid comprising an oil-wetting surfactant may be introduced before the treatment fluid to after the wettability of the particulates and/or the subterranean formation.

The pump 20 can be configured to raise the pressure of the treatment fluid to a desired degree before its introduction into the tubular 16. It is to be recognized that the system 1 is merely exemplary in nature and various additional components can be present that have not necessarily been depicted in FIG. 1 in the interest of clarity. Non-limiting additional components that can be present include, but are not limited to, supply hoppers, valves, condensers, adapters, joints, gauges, sensors, compressors, pressure controllers, pressure sensors, flow rate controllers, flow rate sensors, temperature sensors, and the like.

It should be clearly understood that the example system illustrated by FIG. 1 is merely a general application of the principles of this disclosure in practice, and a wide variety of other examples are possible. Therefore, the scope of this disclosure is not limited in any manner to the details of FIG. 1 as described herein.

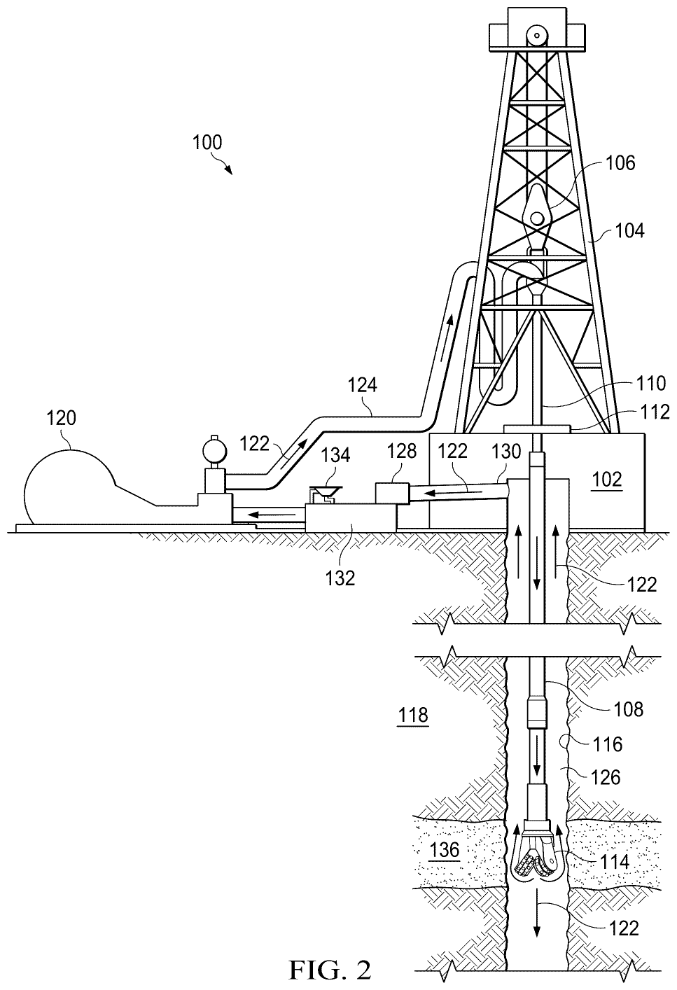

FIG. 2 illustrates a schematic of a drilling assembly 100 in which a drilling fluid 122 may be used. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 may support the drill string 108 as it is lowered through a rotary table 112. A drill bit 114 may be attached to the distal end of the drill string 108 and may be driven either by a downhole motor and/or via rotation of the drill string 108 from the well surface. The drill bit 114 may include, but is not limited to, roller cone bits, PDC bits, natural diamond bits, any hole openers, reamers, coring bits, etc. As the drill bit 114 rotates, it may create a wellbore 116 that penetrates various subterranean formations 118. In an embodiment, the drill bit 114 may penetrate reservoir section 136 and a drilling fluid 122, as disclosed herein, may be circulated in the wellbore 116 during the drilling of the reservoir section 136.

The drilling fluid 122 comprises a treatment fluid, as described herein, as one of its component parts. A pump 120 (e.g., a mud pump) may circulate the drilling fluid 122 through a feed pipe 124 and to the kelly 110, which conveys the drilling fluid 122 downhole through the interior of the drill string 108 and through one or more orifices in the drill bit 114 and into the wellbore 116 portion penetrating the reservoir section 136. The treatment fluid portion of the drilling fluid 122 may then contact particulates and/or targeted areas of the subterranean formation, such as weakened or unstable areas. The treatment fluid may consolidate these particulates and/or targeted areas as described.

The drilling fluid 122 may then be circulated back to the surface via an annulus 126 defined between the drill string 108 and the walls of the wellbore 116. At the surface, the recirculated or spent drilling fluid 122 may exit the annulus 126 and may be conveyed to one or more fluid processing unit(s) 128 via an interconnecting flow line 130. The fluid processing unit(s) 128 may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, and/or any fluid reclamation equipment. The fluid processing unit(s) 128 may further include one or more sensors, gauges, pumps, compressors, and the like used store, monitor, regulate, and/or recondition the drilling fluid 122.

After passing through the fluid processing unit(s) 128, a “cleaned” drilling fluid 122 may be deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure. One or more drilling fluid additives may be added to the drilling fluid 122 via a mixing hopper 134 communicably coupled to or otherwise in fluid communication with the retention pit 132. In some examples, the drilling fluid additives comprise additional amounts of the treatment fluid components (e.g., the furfuryl alcohol monomer, delayed-release acid activator, oil-wetting surfactant, etc.) that may be added to the drilling fluid 122 via the mixing hopper. The mixing hopper 134 may include, but is not limited to, mixers and related mixing equipment known to those skilled in the art. Alternatively, the drilling fluid additives may be added to the drilling fluid 122 at any other location in the drilling assembly 100. While FIG. 2 shows only a single retention pit 132, there could be more than one retention pit 132, such as multiple retention pits 132 in series. Moreover, the retention pit 132 may be representative of one or more fluid storage facilities and/or units where the drilling fluid additives may be stored, reconditioned, and/or regulated until added to the drilling fluid 122.

It should be clearly understood that the example system illustrated by FIG. 2 is merely a general application of the principles of this disclosure in practice, and a wide variety of other examples are possible. Therefore, the scope of this disclosure is not limited in any manner to the details of FIG. 2 as described herein.

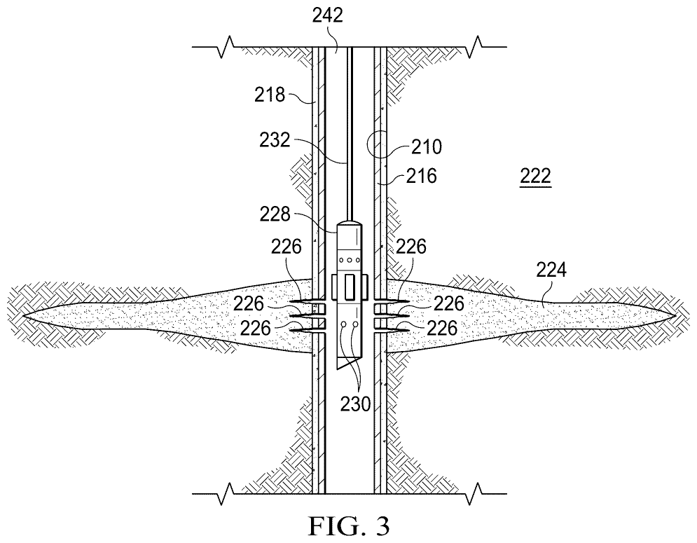

FIG. 3 is a cross-section illustrating the use of the treatment fluids described herein to consolidate proppant within a fracture of a subterranean formation. In a hydraulic fracturing operation, a fracture 224 is formed in a subterranean formation 222 of the wellbore 210. To initiate the operation, perforations 226 are made that penetrate through the casing 216, the cement sheath 218, and into the subterranean formation 222. After perforation of the subterranean formation 222, a treatment fluid is introduced into the fractured portion of the subterranean formation 222 through the perforations 226. While the subterranean formation 222 may be perforated using any suitable technique, the present example utilizes a jetting tool 228. The jetting tool 228 may be any suitable assembly for use in subterranean operations through which a fluid may be jetted at high pressures. By way of example, when used to form the perforations 226, the jetting tool 228 should be configured to jet a fluid against the casing 216 and the cement sheath 218 such that perforations 226 may be formed. As illustrated, the jetting tool 228 may contain ports 230 for discharging a fluid from the jetting tool 228.

In operation, the jetting tool 228 may be positioned in the wellbore 210 adjacent the portion of the wellbore 210 where fracture formation is desired. As illustrated, the jetting tool 228 may be coupled to a work string 232 (e.g., piping, coiled tubing, etc.) and lowered into the wellbore 210 to the desired position. Once the jetting tool 228 has been so positioned, a fluid may be pumped down through the work string 232, into the jetting tool 228, out through the ports 230, and against the interior surface of the casing 216 causing perforations 226 to be formed through the casing 216 and the cement sheath 218.

In accordance with the examples described herein, a proppant-laden fluid may be introduced into the fracture 224 via the jetting tool 228 or other such delivery tool. The treatment fluid may be introduced into the fracture 224 after the proppant is placed within the fracture 224 so as to consolidate the proppant, strengthening the formed proppant structure(s), and reducing proppant flowback out of the fracture 224. As the treatment fluid is injected into the fracture 224, it will flow into the fracture contacting, bonding with, and aggregating the contacted proppant therein.

Alternative wellbore tools for introduction of the treatment fluid may include, but are not limited to, bull heading, coil tubing, or jointed pipe (e.g., with straddle packers, jetting tools, etc.). In the present example, the treatment fluid is injected into the fracture 224 by the jetting tool 228 while the jetting tool 228 is still in position in the wellbore 210. Utilization of the jetting tool 228 may reduce the need for equipment, such as packers, to isolate the treated formation interval. Alternatively, the treatment fluid may be injected through the annulus 242 between the work string 232 and the casing 216.

It should be clearly understood that the example system illustrated by FIG. 3 is merely a general application of the principles of this disclosure in practice, and a wide variety of other examples are possible. Therefore, the scope of this disclosure is not limited in any manner to the details of FIG. 3 as described herein.

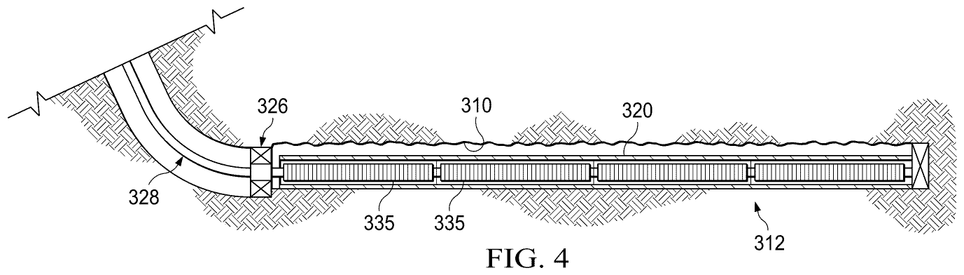

FIG. 4 is a cross-section illustrating a formation or sand consolidation operation using the treatment fluids described herein. An open-hole wellbore 310 extends into an unconsolidated subterranean formation or zone 312 from a cased wellbore extending to the surface. While wellbore 310 is illustrated as a horizontal open-hole completion, it should be recognized that the present invention is also applicable to vertical or inclined wellbores, as well as to cased wellbores.

A sand screen 320 is located inside the wellbore 310. A packer 326 is attached to the sand screen 320. The packer 326 may be used to isolate a portion of the wellbore 310. A washpipe 328 is attached to the service tool and is run inside the sand screen 320. The washpipe 328 is used to force fluid to flow around the bottom section of the sand screen 320.

The sand screen 320 may be of a single length or it may be comprised of a plurality of screen units 335 which are connected together with threaded couplings or the like (not shown). Each of the screen units 335 are similar or identical to each other and each is comprised of a perforated base pipe having a continuous length of wrap wire wound thereon, forming a screened section therein. The base pipe can have a plurality of perforations. Alternatively, other types of permeable base pipes, e.g., slotted pipe, etc., can be used without departing from the present examples.

A treatment fluid as described herein may be placed in the unconsolidated subterranean formation 312 by injecting the treatment fluid directly through the sand screen 320. In some examples, the treatment fluid is placed without pumping the treatment fluid through a gravel pack. The treatment fluid is placed in the subterranean formation 312 by direct injection as a means to prevent damage due to formation fines migration or as a remedial treatment to cure a sand production problem. In addition, the treatment fluid can be used to help reduce proppant flowback from a propped fracture by placing the treatment fluid into the subterranean formation 312 so as to displace and push the unconsolidated particulates (whether proppant or formation fines) into the subterranean formation 312 or deeper into the proppant pack where these particulates may be held in place with the cured treatment fluid. The treatment fluid may be used to consolidate a portion of the subterranean formation 312 after contact and curing of the treatment fluid. The cured treatment fluid may stabilize the formation, thereby preventing formation damage and reducing risks to further wellbore operations. Additionally, fines produced by the subterranean formation 312 may be consolidated and aggregated such that flow into wellbore equipment is prevented.

It should be clearly understood that the example system illustrated by FIG. 4 is merely a general application of the principles of this disclosure in practice, and a wide variety of other examples are possible. Therefore, the scope of this disclosure is not limited in any manner to the details of FIG. 4 as described herein.

The treatment fluids disclosed herein may directly or indirectly affect one or more components or pieces of equipment associated with or which may come into contact with the treatment fluids such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

Provided are treatment fluids for performing a consolidation operation in accordance with the disclosure and the illustrated FIGs. An example treatment fluid comprises an aqueous base fluid, a furfuryl alcohol monomer, a delayed-release acid activator, an oil-wetting surfactant, and a silane coupling agent.

Additionally or alternatively, the treatment fluids may include one or more of the following features individually or in combination. The treatment fluid may further comprise a metal salt catalyst. The treatment fluid may be foamed. The furfuryl alcohol monomer may be present in the treatment fluid in a concentration in a range of about 0.1% w/v to about 80% w/v. The delayed-release acid activator may be selected from the group consisting of esters, acid chlorides, orthoesters, formates, lactides, lactic acid derivatives, carbonates, amino acids, glycolides, ε-caprolactones, hydroxy ester ethers, hydroxybutyrates, anhydrides, phosphazenes, methyl lactate, ethyl lactate, propyl lactate, butyl lactate, formate esters (e.g., ethylene glycol monoformate, ethylene glycol diformate, diethylene glycol diformate, glyceryl monoformate, glyceryl diformate, glyceryl triformate, triethylene glycol diformate and formate esters of pentaerythritol), esters or polyesters of glycerol (e.g., tripropionin (a triester of propionic acid and glycerol), trilactin, etc.) esters of acetic acid and glycerol (e.g., monoacetin, diacetin, and triacetin), sulfonate esters (e.g., methyl p-toluenesulfonate, ethyl p-toluenesulfonate, methyl methanesulfonate, ethyl methanesulfonate, methyl benzenesulfonate, ethyl benzenesulfonate, methyl 2,4,6-trimethylbenzenesulfonate, ethyl 2,4,6-trimethylbenzenesulfonate), aliphatic polyesters, poly(lactides), poly(glycolides), poly(ε-caprolactones), poly(hydroxy ester ethers), poly(hydroxybutyrates), poly(anhydrides), aliphatic polycarbonates, poly(orthoesters), poly(amino acids), poly(ethylene oxides), polyphosphazenes, copolymers thereof, and any combination thereof. The delayed-release acid activator may be present in the treatment fluid in a concentration in a range of about 0.1% w/v to about 25% w/v. The oil-wetting surfactant may be selected from the group consisting of alkyl phosphonate surfactants, ethoxylated nonyl phenol phosphonate esters, ethoxylated C₁₂-C₂₂ diamine, ethoxylated C₁₂-C₂₂ triamine, ethoxylated C₁₂-C₂₂ tetraamine, ethoxylated C₁₂-C₂₂ diamine methylchloride quat, ethoxylated C₁-C₂₂ triamine methylchloride quat, ethoxylated C₁₂-C₂₂ tetraamine methylchloride quat, ethoxylated C₁₂-C₂₂ diamine reacted with sodium chloroacetate, ethoxylated C₁₂-C₂₂ triamine reacted with sodium chloroacetate, ethoxylated C₁₂-C₂₂ tetraamine reacted with sodium chloroacetate, ethoxylated C₁₂-C₂₂ diamine acetate salt, ethoxylated C₁₂-C₂₂ diamine hydrochloric acid salt, ethoxylated C₁₂-C₂₂ diamine glycolic acid salt, ethoxylated C₁₂-C₂₂ diamine DDBSA (dodecyl benzene sulfonic acid) salt, ethoxylated C₁₂-C₂₂ triamine acetate salt, ethoxylated C₁₂-C₂₂ triamine hydrochloric acid salt, ethoxylated C₁₂-C₂₂ triamine glycolic acid salt, ethoxylated C₁₂-C₂₂ triamine DDBSA salt, ethoxylated C₁₂-C₂₂ tetraamine acetate salt, ethoxylated C₁₂-C₂₂ tetraamine hydrochloric acid salt, ethoxylated C₁₂-C₂₂ tetraamine glycolic acid salt, ethoxylated C₁₂-C₂₂ tetraamine DDBSA salt, pentamethylated C₁₂-C₂₂ diamine quat, heptamethylated C₁₂-C₂₂ diamine quat, nonamethylated C₁₂-C₂₂ diamine quat, and combinations thereof. The oil-wetting surfactant may be present in the treatment fluid in a concentration in a range of about 0.1% w/v to about 10% w/v. The silane coupling agent may be an organosilane coupling agent. The silane coupling agent may be present in the treatment fluid in a concentration in a range of about 0.25% to about 10% wt. %.

Provided are methods for performing a consolidation operation with a treatment fluid in accordance with the disclosure and the illustrated FIGs. An example method comprises providing a treatment fluid comprising an aqueous base fluid, a furfuryl alcohol monomer, a delayed-release acid activator, an oil-wetting surfactant, and a silane coupling agent. The method further comprises contacting a particulate and/or a target area of a subterranean formation with the treatment fluid.

Additionally or alternatively, the method may include one or more of the following features individually or in combination. The contacting the particulate and/or the target area of the subterranean formation may occur in an area having a temperature of 150° F. or less. The treatment fluid may be a component of a drilling fluid and the method further comprises drilling through the target area of the subterranean formation with the drilling fluid. The method may further comprise acidizing the target area of the subterranean formation and the treatment fluid contacts the target area of the subterranean formation. The particulate may be a proppant. The method may further comprise pumping the treatment fluid through a sand screen to contact the target area of the subterranean formation. The sand screen may not comprise a gravel pack. An activator or catalyst fluid may not be introduced after the treatment fluid. The treatment fluid may further comprise a metal salt catalyst. The treatment fluid may be foamed. The furfuryl alcohol monomer may be present in the treatment fluid in a concentration in a range of about 0.1% w/v to about 80% w/v. The delayed-release acid activator may be selected from the group consisting of esters, acid chlorides, orthoesters, formates, lactides, lactic acid derivatives, carbonates, amino acids, glycolides, ε-caprolactones, hydroxy ester ethers, hydroxybutyrates, anhydrides, phosphazenes, methyl lactate, ethyl lactate, propyl lactate, butyl lactate, formate esters (e.g., ethylene glycol monoformate, ethylene glycol diformate, diethylene glycol diformate, glyceryl monoformate, glyceryl diformate, glyceryl triformate, triethylene glycol diformate and formate esters of pentaerythritol), esters or polyesters of glycerol (e.g., tripropionin (a triester of propionic acid and glycerol), trilactin, etc.) esters of acetic acid and glycerol (e.g., monoacetin, diacetin, and triacetin), sulfonate esters (e.g., methyl p-toluenesulfonate, ethyl p-toluenesulfonate, methyl methanesulfonate, ethyl methanesulfonate, methyl benzenesulfonate, ethyl benzenesulfonate, methyl 2,4,6-trimethylbenzenesulfonate, ethyl 2,4,6-trimethylbenzenesulfonate), aliphatic polyesters, poly(lactides), poly(glycolides), poly(ε-caprolactones), poly(hydroxy ester ethers), poly(hydroxybutyrates), poly(anhydrides), aliphatic polycarbonates, poly(orthoesters), poly(amino acids), poly(ethylene oxides), polyphosphazenes, copolymers thereof, and any combination thereof. The delayed-release acid activator may be present in the treatment fluid in a concentration in a range of about 0.1% w/v to about 25% w/v. The oil-wetting surfactant may be selected from the group consisting of alkyl phosphonate surfactants, ethoxylated nonyl phenol phosphonate esters, ethoxylated C₁₂-C₂₂ diamine, ethoxylated C₁₂-C₂₂ triamine, ethoxylated C₁₂-C₂₂ tetraamine, ethoxylated C₁₂-C₂₂ diamine methylchloride quat, ethoxylated C₁₂-C₂₂ triamine methylchloride quat, ethoxylated C₁₂-C₂₂ tetraamine methylchloride quat, ethoxylated C₁₂-C₂₂ diamine reacted with sodium chloroacetate, ethoxylated C₁₂-C₂₂ triamine reacted with sodium chloroacetate, ethoxylated C₁₂-C₂₂ tetraamine reacted with sodium chloroacetate, ethoxylated C₁₂-C₂₂ diamine acetate salt, ethoxylated C₁₂-C₂₂ diamine hydrochloric acid salt, ethoxylated C₁₂-C₂₂ diamine glycolic acid salt, ethoxylated C₁₂-C₂₂ diamine DDBSA (dodecyl benzene sulfonic acid) salt, ethoxylated C₁₂-C₂₂ triamine acetate salt, ethoxylated C₁₂-C₂₂ triamine hydrochloric acid salt, ethoxylated C₁₂-C₂₂ triamine glycolic acid salt, ethoxylated C₁₂-C₂₂ triamine DDBSA salt, ethoxylated C₁₂-C₂₂ tetraamine acetate salt, ethoxylated C₁₂-C₂₂ tetraamine hydrochloric acid salt, ethoxylated C₁₂-C₂₂ tetraamine glycolic acid salt, ethoxylated C₁₂-C₂₂ tetraamine DDBSA salt, pentamethylated C₁₂-C₂₂ diamine quat, heptamethylated C₁₂-C₂₂ diamine quat, nonamethylated C₁₂-C₂₂ diamine quat, and combinations thereof. The oil-wetting surfactant may be present in the treatment fluid in a concentration in a range of about 0.1% w/v to about 10% w/v. The silane coupling agent may be an organosilane coupling agent. The silane coupling agent may be present in the treatment fluid in a concentration in a range of about 0.25% to about 10% wt. %.

Provided are systems for performing a consolidation operation with a treatment fluid in accordance with the disclosure and the illustrated FIGs. An example system comprises a treatment fluid comprising an aqueous base fluid, a furfuryl alcohol monomer, a delayed-release acid activator, an oil-wetting surfactant, and a silane coupling agent. The system further comprises mixing equipment configured to mix the aqueous base fluid, furfuryl alcohol monomer, the delayed-release acid activator, the oil-wetting surfactant, and the silane coupling agent; and pumping equipment configured to pump the treatment fluid in the wellbore.

Additionally or alternatively, the system may include one or more of the following features individually or in combination. The system may further comprise a drill string and a drill bit and the treatment fluid is pumped through the drill string and the drill bit. The system may further comprise a sand screen and the treatment fluid is pumped through the sand screen.

The sand screen may not contain a gravel pack. The treatment fluid may further comprise a metal salt catalyst. The treatment fluid may be foamed. The furfuryl alcohol monomer may be present in the treatment fluid in a concentration in a range of about 0.1% w/v to about 80% w/v. The delayed-release acid activator may be selected from the group consisting of esters, acid chlorides, orthoesters, formates, lactides, lactic acid derivatives, carbonates, amino acids, glycolides, ε-caprolactones, hydroxy ester ethers, hydroxybutyrates, anhydrides, phosphazenes, methyl lactate, ethyl lactate, propyl lactate, butyl lactate, formate esters (e.g., ethylene glycol monoformate, ethylene glycol diformate, diethylene glycol diformate, glyceryl monoformate, glyceryl diformate, glyceryl triformate, triethylene glycol diformate and formate esters of pentaerythritol), esters or polyesters of glycerol (e.g., tripropionin (a triester of propionic acid and glycerol), trilactin, etc.) esters of acetic acid and glycerol (e.g., monoacetin, diacetin, and triacetin), sulfonate esters (e.g., methyl p-toluenesulfonate, ethyl p-toluenesulfonate, methyl methanesulfonate, ethyl methanesulfonate, methyl benzenesulfonate, ethyl benzenesulfonate, methyl 2,4,6-trimethylbenzenesulfonate, ethyl 2,4,6-trimethylbenzenesulfonate), aliphatic polyesters, poly(lactides), poly(glycolides), poly(ε-caprolactones), poly(hydroxy ester ethers), poly(hydroxybutyrates), poly(anhydrides), aliphatic polycarbonates, poly(orthoesters), poly(amino acids), poly(ethylene oxides), polyphosphazenes, copolymers thereof, and any combination thereof. The delayed-release acid activator may be present in the treatment fluid in a concentration in a range of about 0.1% w/v to about 25% w/v. The oil-wetting surfactant may be selected from the group consisting of alkyl phosphonate surfactants, ethoxylated nonyl phenol phosphonate esters, ethoxylated C₁₂-C₂₂ diamine, ethoxylated C₁₂-C₂₂ triamine, ethoxylated C₁₂-C₂₂ tetraamine, ethoxylated C₁₂-C₂₂ diamine methylchloride quat, ethoxylated C₁₂-C₂₂ triamine methylchloride quat, ethoxylated C₁₂-C₂₂ tetraamine methylchloride quat, ethoxylated C₁₂-C₂₂ diamine reacted with sodium chloroacetate, ethoxylated C₁₂-C₂₂ triamine reacted with sodium chloroacetate, ethoxylated C₁₂-C₂₂ tetraamine reacted with sodium chloroacetate, ethoxylated C₁₂-C₂₂ diamine acetate salt, ethoxylated C₁₂-C₂₂ diamine hydrochloric acid salt, ethoxylated C₁₂-C₂₂ diamine glycolic acid salt, ethoxylated C₁₂-C₂₂ diamine DDBSA (dodecyl benzene sulfonic acid) salt, ethoxylated C₁₂-C₂₂ triamine acetate salt, ethoxylated C₁₂-C₂₂ triamine hydrochloric acid salt, ethoxylated C₁₂-C₂₂ triamine glycolic acid salt, ethoxylated C₁₂-C₂₂ triamine DDBSA salt, ethoxylated C₁₂-C₂₂ tetraamine acetate salt, ethoxylated C₁₂-C₂₂ tetraamine hydrochloric acid salt, ethoxylated C₁₂-C₂₂ tetraamine glycolic acid salt, ethoxylated C₁₂-C₂₂ (etraanine DDBSA salt, pentamethylated C₁₂-C₂₂ diamine quat, heptamethylated C₁₂-C₂₂ diamine quat, nonamethylated C₁₂-C₂₂ diamine quat, and combinations thereof. The oil-wetting surfactant may be present in the treatment fluid in a concentration in a range of about 0.1% w/v to about 10% w/v. The silane coupling agent may be an organosilane coupling agent. The silane coupling agent may be present in the treatment fluid in a concentration in a range of about 0.25% to about 10% wt. %.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A treatment fluid for a consolidation operation, the treatment fluid comprises:
an aqueous base fluid,
a furfuryl alcohol monomer,
a delayed-release acid activator,
an oil-wetting surfactant, and
a silane coupling agent.

2. The treatment fluid of claim 1, further comprising a metal salt catalyst.

3. The treatment fluid of claim 1, wherein the treatment fluid is foamed.

4. The treatment fluid of claim 1, wherein the furfuryl alcohol monomer is present in the treatment fluid in a concentration in a range of about 0.1% w/v to about 80% w/v.

5. The treatment fluid of claim 1, wherein the delayed-release acid activator is selected from the group consisting of esters, acid chlorides, orthoesters, formates, lactides, lactic acid derivatives, carbonates, amino acids, glycolides, ε-caprolactones, hydroxy ester ethers, hydroxybutyrates, anhydrides, phosphazenes, methyl lactate, ethyl lactate, propyl lactate, butyl lactate, formate esters (e.g., ethylene glycol monoformate, ethylene glycol diformate, diethylene glycol diformate, glyceryl monoformate, glyceryl diformate, glyceryl triformate, triethylene glycol diformate and formate esters of pentaerythritol), esters or polyesters of glycerol (e.g., tripropionin (a triester of propionic acid and glycerol), trilactin, etc.) esters of acetic acid and glycerol (e.g., monoacetin, diacetin, and triacetin), sulfonate esters (e.g., methyl p-toluenesulfonate, ethyl p-toluenesulfonate, methyl methanesulfonate, ethyl methanesulfonate, methyl benzenesulfonate, ethyl benzenesulfonate, methyl 2,4,6-trimethylbenzenesulfonate, ethyl 2,4,6-trimethylbenzenesulfonate), aliphatic polyesters, poly(lactides), poly(glycolides), poly(ε-caprolactones), poly(hydroxy ester ethers), poly(hydroxybutyrates), poly(anhydrides), aliphatic polycarbonates, poly(orthoesters), poly(amino acids), poly(ethylene oxides), polyphosphazenes, copolymers thereof, and any combination thereof.

6. The treatment fluid of claim 1, wherein the delayed-release acid activator is present in the treatment fluid in a concentration in a range of about 0.1% w/v to about 25% w/v.

7. The treatment fluid of claim 1, wherein the oil-wetting surfactant is selected from the group consisting of alkyl phosphonate surfactants, ethoxylated nonyl phenol phosphonate esters, ethoxylated C₁₂-C₂₂ diamine, ethoxylated C₁₂-C₂₂ triamine, ethoxylated C₁₂-C₂₂ tetraamine, ethoxylated C₁₂-C₂₂ diamine methylchloride quat, ethoxylated C₁₂-C₂₂ triamine methylchloride quat, ethoxylated C₁₂-C₂₂ tetraamine methylchloride quat, ethoxylated C₁₂-C₂₂ diamine reacted with sodium chloroacetate, ethoxylated C₁₂-C₂₂ triamine reacted with sodium chloroacetate, ethoxylated C₁₂-C₂₂ tetraamine reacted with sodium chloroacetate, ethoxylated C₁₂-C₂₂ diamine acetate salt, ethoxylated C₁₂-C₂₂ diamine hydrochloric acid salt, ethoxylated C₁₂-C₂₂ diamine glycolic acid salt, ethoxylated C₁₂-C₂₂ diamine DDBSA (dodecyl benzene sulfonic acid) salt, ethoxylated C₁₂-C₂₂ triamine acetate salt, ethoxylated C₁₂-C₂₂ triamine hydrochloric acid salt, ethoxylated C₁₂-C₂₂ triamine glycolic acid salt, ethoxylated C₁₂-C₂₂ triamine DDBSA salt, ethoxylated C₁₂-C₂₂ tetraamine acetate salt, ethoxylated C₁₂-C₂₂ tetraamine hydrochloric acid salt, ethoxylated C₁₂-C₂₂ tetraamine glycolic acid salt, ethoxylated C₁₂-C₂₂ tetraamine DDBSA salt, pentamethylated C₁₂-C₂₂ diamine quat, heptamethylated C₁₂-C₂₂ diamine quat, nonamethylated C₁₂-C₂₂ diamine quat, and combinations thereof.

8. The treatment fluid of claim 1, wherein the oil-wetting surfactant is present in the treatment fluid in a concentration in a range of about 0.1% w/v to about 10% w/v.

9. The treatment fluid of claim 1, wherein the silane coupling agent is an organosilane coupling agent.

10. The treatment fluid of claim 1, wherein the silane coupling agent is present in the treatment fluid in a concentration in a range of about 0.25% to about 10% wt. %.

11. A method for performing a consolidation operation, the method comprises:
providing a treatment fluid comprising:
an aqueous base fluid,
a furfuryl alcohol monomer,
a delayed-release acid activator,
an oil-wetting surfactant, and
a silane coupling agent; and
contacting a particulate and/or a target area of a subterranean formation with the treatment fluid.

12. The method of claim 11, wherein the contacting the particulate and/or the target area of the subterranean formation occurs in an area having a temperature of 150° F. or less.

13. The method of claim 11, wherein the treatment fluid is a component of a drilling fluid and the method further comprises drilling through the target area of the subterranean formation with the drilling fluid.

14. The method of claim 11, wherein the method further comprises acidizing the target area of the subterranean formation and the treatment fluid contacts the target area of the subterranean formation.

15. The method of claim 11, wherein the particulate is a proppant.

16. The method of claim 11, wherein the method further comprises pumping the treatment fluid through a sand screen to contact the target area of the subterranean formation; wherein the sand screen does not comprise a gravel pack.

17. The method of claim 11, wherein an activator or catalyst fluid is not introduced after the treatment fluid.

18. A system for performing a consolidation operation, the system comprises:
a treatment fluid comprising:
an aqueous base fluid,
a furfuryl alcohol monomer,
a delayed-release acid activator,
an oil-wetting surfactant, and
a silane coupling agent;
mixing equipment configured to mix the aqueous base fluid, furfuryl alcohol monomer, the delayed-release acid activator, the oil-wetting surfactant, and the silane coupling agent; and
pumping equipment configured to pump the treatment fluid in the wellbore.

19. The system of claim 18, further comprising a drill string and a drill bit; wherein the treatment fluid is pumped through the drill string and the drill bit.

20. The system of claim 18, further comprising a sand screen; wherein the treatment fluid is pumped through the sand screen; wherein the sand screen does not contain a gravel pack.
